(19) United States
(12) Patent Application Publication
(10) Pub. No.: US 2006/0271640 A1
(43) Pub. Date: Nov. 30, 2006

(54) Apparatus and methods for remote administration of neuropyschological tests

(76) Inventors: Phillip L. Muldoon, Gulf Breeze, FL (US); Dennis L. Reeves, Springfield, MO (US); Kathryn P. Winter, Pensacola Beach, FL (US)

Correspondence Address: CAHN & SAMUELS LLP, 2000 P STREET NW, SUITE 200, WASHINGTON, DC, 20036, US

(21) Appl. No.: 11/386,086

(22) Filed: Mar. 22, 2006

Related U.S. Application Data
(60) Provisional application No. 60/663,765, filed on Mar. 22, 2005.

(51) Int. Cl. G06F 15/16

(52) U.S. Cl. 709/217

(57) ABSTRACT

A method for remotely administering automated neuropsychological/neurocognitive tests on a client computing device includes downloading a test module associated with the user to the client computing device and executing the test module. Test data generated during text execution is transmitted to a central server, for example, and the test module and the test data are then deleted from the client-computing device.

### I. CROSS REFERENCE TO RELATED APPLICATIONS

This application claims the benefit of provisional application Ser. No. 60/663,765 filed Mar. 22, 2005, which is incorporated herein by reference.

This application is related to application Ser. No. 11/305,332 filed Dec. 19, 2005, application Ser. No. 10/614,758 filed Jul. 8, 2003, and application Ser. No. 10/140,376 filed May 8, 2002, now U.S. Pat. No. 6,669,481.

### II. FIELD OF THE INVENTION

This invention relates to administration of neuropsychological tests. More particularly, the invention relates to apparatus and methods for remote administration of neuropsychological or neurocognitive tests.

### Ill. BACKGROUND OF THE INVENTION

As in almost every other field, the modern-day computer has made its way into the neuropsychological testing field. Neuropsychologists, clinicians, and sometimes patients administer computerized automated neuropsychological tests for a variety of purposes. Computerized neuropsychological testing is ideal for a number of reasons. First, it allows for stimuli to be presented in a random form, thereby creating almost limitless combinations. Secondly, both individual and group testing may be accomplished with ease. Thirdly, the administrator can administer the tests, and, in some cases, interpret test results without the need for formal neuropsychological training. Finally, computerized neuropsychological testing results in a significant cost and time savings.

An early cognitive test system was the microcomputer-based testing system (MTS), an Apple® II-based system created to test cognitive skills. The system was developed in cooperation with the United States Environmental Protection Agency (EPA). It was used to test subjects for cognitive functions such as perception, reaction time, reasoning and decision making, and memory.

Perhaps, one of the most famous automated/computerized neuropsychological testing packages is the Automated Neuropsychological Assessment Metrics (ANAM) system, a system of batteries of cognitive tests modified by neuropsychologists in the U.S. Armed Forces for precise measurement of cognitive processing efficiency of troops. ANAM has been used to test subjects for sustained concentration and attention, mental flexibility, spatial processing, cognitive processing efficiency, mood, arousal/fatigue level, and short-term, working, and long-term memory.

Non-computerized neuropsychological tests have certain shortcomings such as a limited number of combinations of stimuli presentations and a limited speed with which a test can be administered. In addition, it is difficult for a person having limited neuropsychological training to reliably administer the tests.

Known computerized neuropsychological tests, however, also have shortcomings. A shortcoming of the currently available computerized tests is that many of the computerized tests offer complex results, and the test administrator may exhaust a significant amount of time analyzing the results. The currently available neuropsychological computerized testing packages do not offer a simplified version of the results of each test to assist the test administrator in quickly analyzing the results of the computerized tests.

Another shortcoming with the currently available computerized neuropsychological testing programs is that control of the content of the various tests is limited, as many of the control parameters are hard-coded. For example, many of the computerized neuropsychological tests employ control parameters such as a time value representing a length of time a particular stimulus should be displayed to a user and a time value representing the length of time a user is given to respond to the stimulus. The time values may require adjustment to accommodate the various types of test subjects. For instance, an elderly person may have slow reflexes and require more time for the stimulus to be displayed and/or more time to respond to the stimulus. To alter the timing based on the individual test subjects, computer programmers must alter the code of the computerized neuropsychological testing program every time a change in the timing is desired.

In many applications, it is desirable to administer automated neuropsychological tests remotely over a communication medium such as the Internet. Remote administration allows patients execute a test and directly upload the test data to a centralized database server. When the automated tests are administered on a stand-alone machine, the patient typically stores the test data on a storage medium, e.g., a CD-ROM, a DVD, a memory stick, a floppy disk, etc., and physically delivers the storage medium to the database administrator who then uploads the test data to the database server. This can sometimes lead to lost or unreported test data.

It is further desirable to prevent a patient from “learning” the automated test by repeatedly taking the test before recording their score. Such a practice defeats much of the purpose of neuropsychological testing and often leads to test results that may cause erroneous conclusions to be drawn regarding a given neuropsychological condition under study.

### IV. SUMMARY OF THE INVENTION

It is an object of the invention to provide a controlled method to remotely administer neuropsychological tests.

It is a further object of the invention to minimize performance degradation in remotely administered neuropsychological tests in comparison with locally administered neuropsychological tests.

In accordance with an aspect of the invention, a method for administering automated neuropsychological tests on a client-computing device where test modules are stored at a remote location is provided. The method includes prompting a user for login information, validating login information received from the user, accessing a user information file resident at a first location responsive to login information, accessing a study information file resident at a second location responsive to the login information where the study information file includes one or more test modules. The method further includes retrieving test modules from a third remote location for each test module identified in the study information file, executing the test modules thereby generating test data files, transmitting the test data files to a fourth remote location, and deleting the test data files and test modules from the client computing device.

Given the following enabling description of the drawings, the invention should become evident to a person of ordinary skill in the art.

### V. BRIEF DESCRIPTION OF THE DRAWINGS

FIG. 1 depicts a flow chart of an embodiment of the invention.

FIG. 2 shows a login screen in accordance with the invention.

FIG. 3 illustrates a screen shot in accordance with an aspect of the invention.

FIG. 4A shows a flow chart of a test administration procedure in accordance with the invention.

FIG. 4B-4D depict test execution screen shots.

FIG. 5 is a flow diagram illustrating the steps involved in a specific type of test of the present invention.

FIG. 6 is a flow diagram illustrating the steps involved in a specific type of test of the present invention.

FIG. 7 is a flow diagram illustrating the steps involved in a specific type of test of the present invention.

FIG. 8 shows a client-computing device in accordance with an embodiment of the invention.

### VI. DETAILED DESCRIPTION OF THE DRAWINGS

The present invention is directed to a method and apparatus for administering automated neuropsychological tests on a client-computing device. A library of automated neuropsychological or neurocognitive test modules are resident on a remote server. The invention includes a method for downloading individual test modules onto a client computing device, executing the downloaded test modules on the client computing device, transmitting the test data generated to remote data storage location and deleting the test data and the test modules from the client computing device.

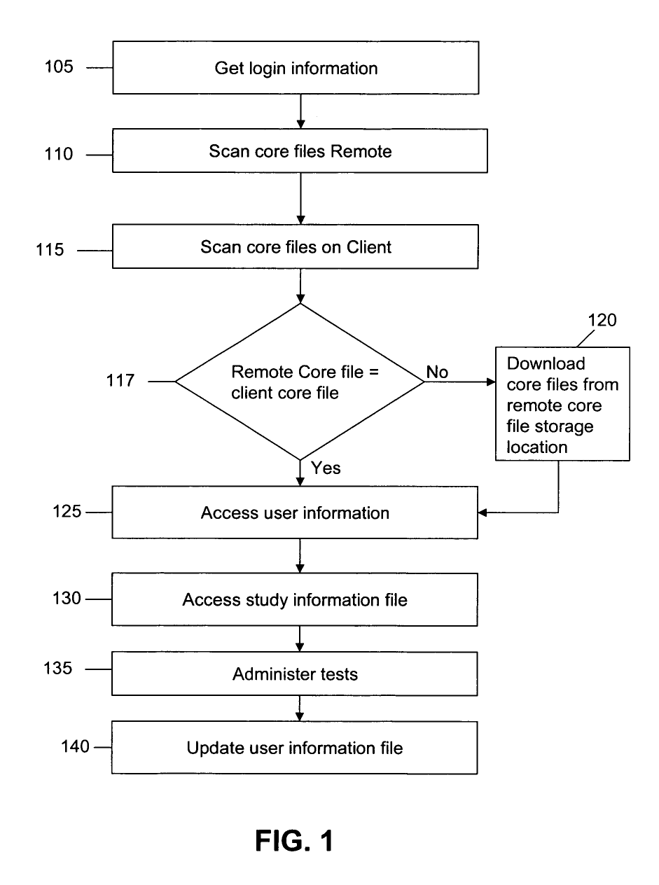

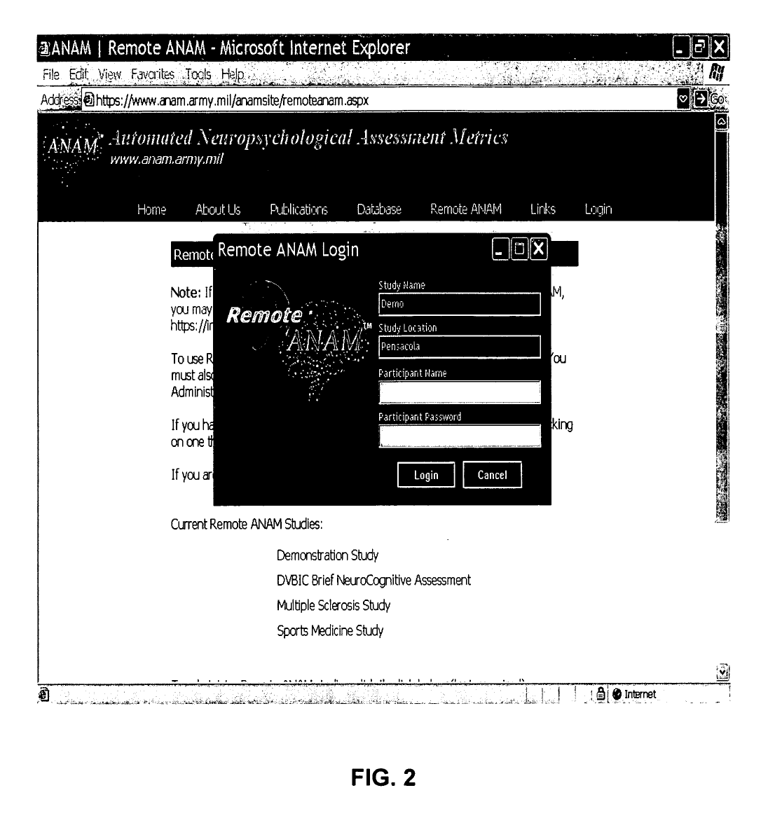

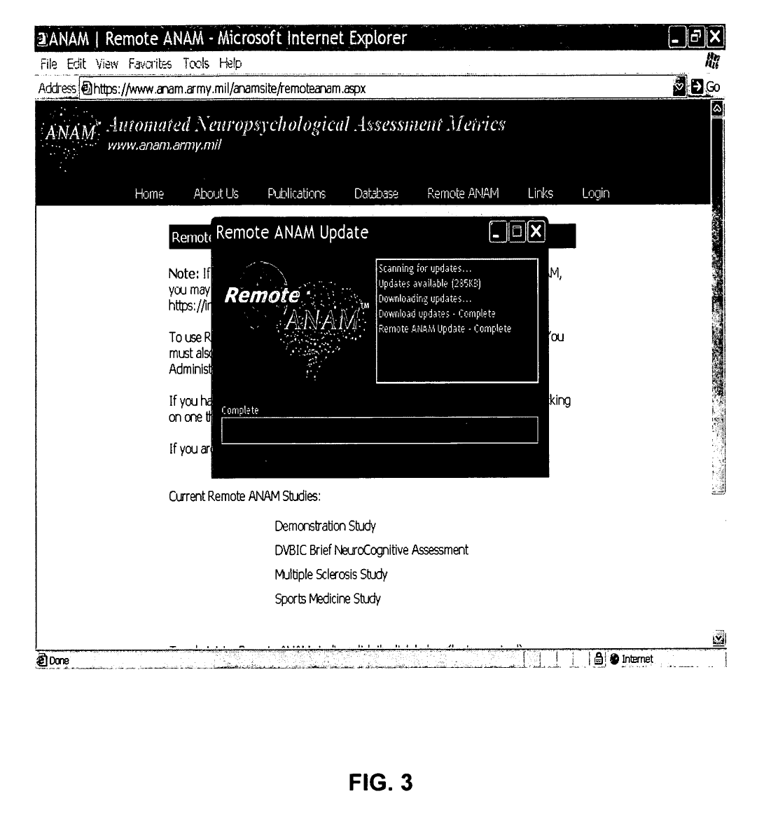

In accordance with method aspects of the invention, as illustrated in FIG. 1, in step 105, a user is prompted for login information. As illustrated in FIG. 2, exemplary login information may include user identification, password, location, and, if part of a study, information identifying the study. Once the patient submits its login information, that information is validated using a web service, for example. In step 110, a remote core file storage location is scanned for a list of core files. As used herein, core files are those files necessary to download and execute automated tests on the client-computing device. In step 115, client directories on the client-computing device are scanned to determine whether core files are present on the client-computing device. If one or more core files are not present, are outdated, or changed, in step 120, the current version of the core files are retrieved from the remote core file storage location as illustrated in FIG. 3.

If core files are present, than flow proceeds to step 125 where the user information file is accessed, e.g., using a web service. The user information file may be a text file that contains the run configuration for a test session. For example, the user information file may contain a run count, and indication of the dominant hand of the user, test language, and other information.

In step 130 the study information file is accessed, e.g., using a web service. The study information file may be a text file that includes the tests to be run, the order in which they should be run and the command line switches for each test.

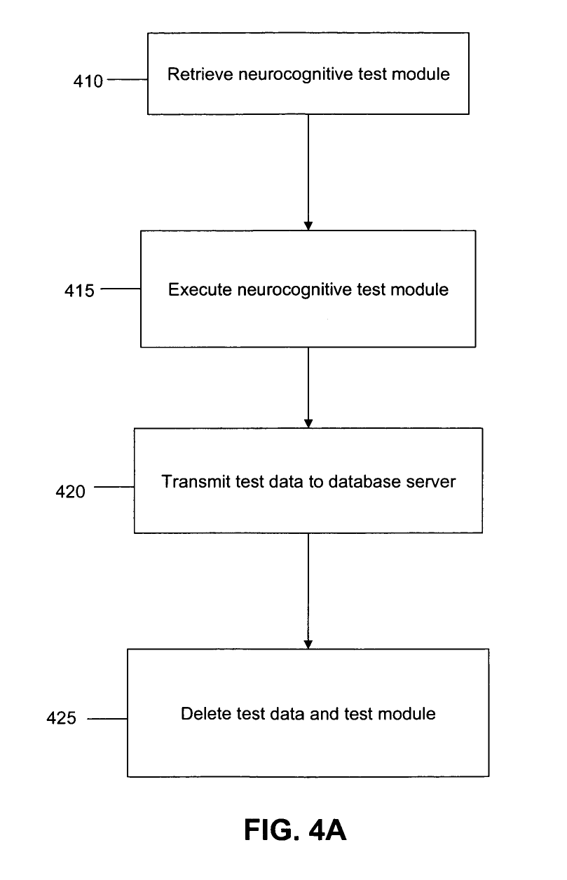

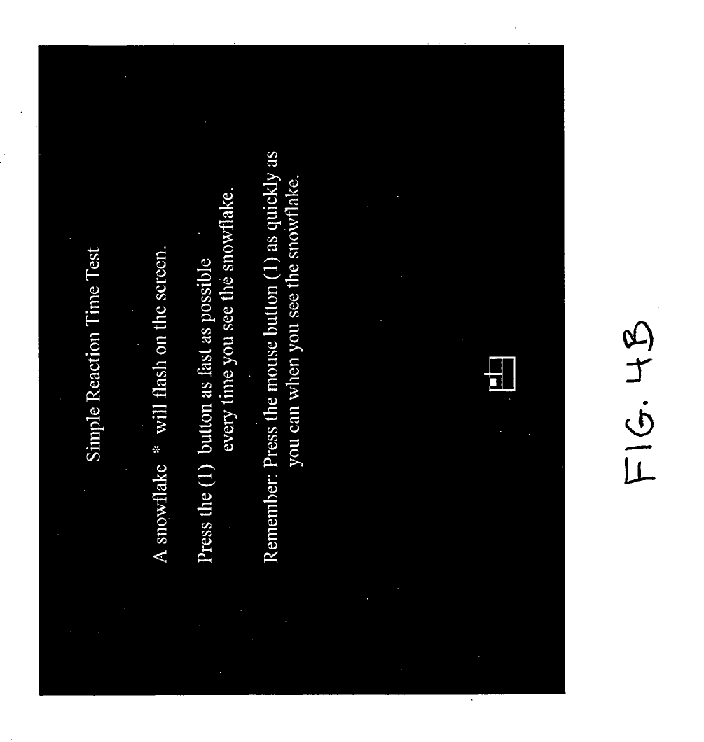

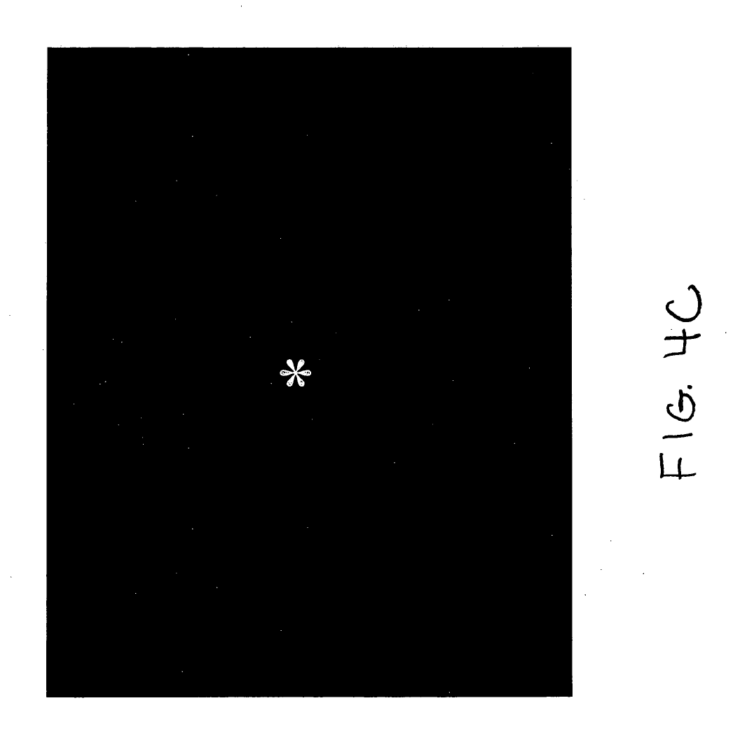

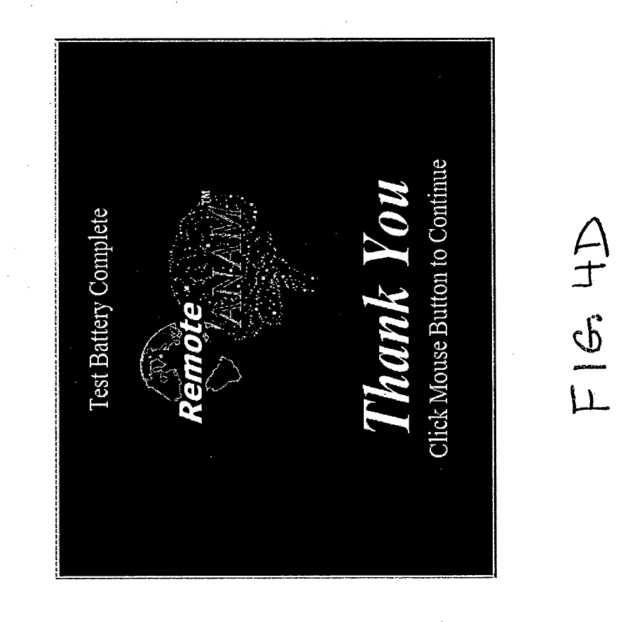

In keeping with the invention, in step 135, the client-computing device administers one or more of the test modules contained in the study file. An exemplary test administration process 400 is described in connection with FIG. 4A. In step 410, one or more test modules are retrieved, e.g., downloaded, by a client-computing device from a remote test module storage location. FIG. 4B. The test module may be an individual test or a battery of tests. In step 415, the test module is executed and test data is generated. FIGS. 4C, 4D and 4E illustrate screen shots of test execution. In step 420, test data is transmitted to a remote test data database, e.g., via a web service. After data transmission, in step 425, the test module and test data are deleted from the client-computing device. Test administration process 400 may be repeated until some or all of the test modules associated with the study have been executed. Removing the test data and the test module(s) from the client-computing device following test execution minimizes the prospect of data corruption and unauthorized test distribution.

In step 140, after all tests have been completed, the user information file is updated and transmitted to a remote user information file storage location, e.g., via a web service.

In accordance with the invention, the remote core file storage location, the remote user information storage location, the remote user file storage location, the remote test file storage location and the remote study file storage location may be a server or other computing device connected to the client computing device via a computer network such as the Internet or an intranet. In some embodiments, the remote locations may be dedicated storage units such as external hard drives, memory sticks or keys, or other media connected to the client-computing device.

In keeping with the invention, the study file may include a library of neurocognitive test modules designed to for analysis of performance degradation from injury, illness, fatigue, medications, chemical exposure, radiation or for measuring any other perceived cognitive loss or gain. The library may include several known neuropsychological tests that have been modified for computer implementation as well as some newly developed neuropsychological tests. The tests are more fully described in co-pending application Ser. No. 11/305,322 which is incorporated by reference herein. The tests include but are not limited to the following: 1) The Modified Stanford Sleepiness Scale, 2) The Mood Scale 2-R, 3) Simple Reaction Time Test, 4) Memory Search Test, 5) Running Memory and Continuous Performance Test, 6) Mathematical Processing Test, 7) Digit Set Comparison Test, 8) Logical Reasoning-Symbolic Test, 9) Code Substitution and Memory Tests, 10) Spatial Processing Test, and 11) Matching to Sample Test. While each test in the library is unique, there are also several common attributes to each test.

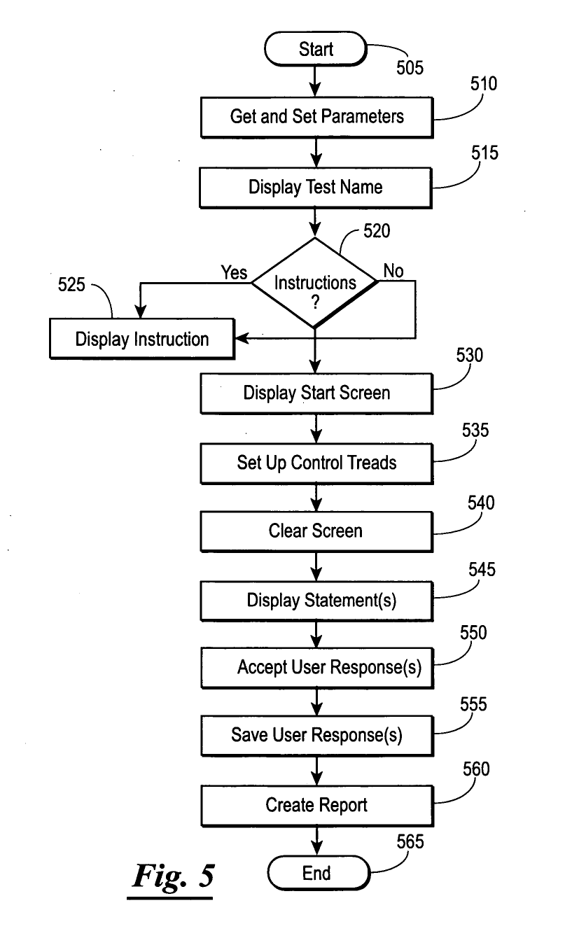

FIG. 5 is a flow diagram illustrating the general steps of an exemplary method of execution for a specific type of test according to an embodiment of the present invention. More specifically, FIG. 5 illustrates the steps involved in a test that presents an on-screen query to the test subject. One of the more popular tests of this type is the Modified Stanford Sleepiness Scale Test, which will be specifically described in further detail below.

Referring now to FIG. 5, flow begins with step 505 and proceeds to step 510. In step 510, a list of switches (parameters) described below is generated. In some embodiments, the USER may have sufficient privileges to select and set one or more of the switches to configure the tests as desired. In other embodiments, only the system administrator has sufficient privileges to alter switches.

In step 515, the name of the test is preferably displayed on the display screen. Control then proceeds to decision step 520. In decision step 520, the program module prompts the user to determine whether she would like instructions for the test. If the user would like instructions for the test, in step 525, the program module communicates a set of user instructions for taking the test. Returning to decision step 520, if the user elects not to have user instructions displayed, an initial start screen is presented, for example, an introductory screen with graphics.

In step 535, control threads are set. In step 540, the display screen is cleared. In step 545, stimuli, e.g., statements for the test, are displayed. For example, the Modified Stanford Sleepiness Scale Test comprises seven descriptive statements used to describe how the test subject feels with respect to alertness or sleepiness. The statements may be displayed to the test subject one at a time or all statements may be displayed simultaneously.

In step 550, the test subject's response to the presentation of the statements presented in previous step 545 is received. For example, the test subject may select one of the statements by highlighting the statement or clicking a radio button corresponding to the particular statement of selection.

In step 555, the test subject's response to the statements is recorded. In step 560, a report is created that includes the test subject's responses to the statements. The report may be displayed or stored for later viewing. Finally, control ends with step 565. The following are examples of neuropsychological tests of the type described with respect to FIG. 5.

Modified Stanford Sleepiness Scale

This test is comprised of a series of statements that describe how one feels with respect to alertness or sleepiness. In a preferred embodiment, this test comprises seven descriptive statements. The program module may display the statements to the test subject one at a time or all simultaneously. In any event, the test subject is directed to select the statement that best describes its feelings at that moment in time. The test subject may make the selection on screen using a mouse, the keyboard or any other known input device. The seven descriptive statements of the preferred embodiment are:

Feeling very alert, wide-awake, and energetic.

Able to concentrate, but not quite at peak.

Relaxed, awake, responsive, but not fully alert.

A little foggy and mild difficulty concentrating.

Foggy, slowed down, beginning to lose interest in remaining awake.

Sleepy, woozy, prefer to be lying down; fighting sleep.

Sleep onset soon, losing struggle to remain awake.

Mood Scale 2-R

This test is designed to assess either mood state or trait in test subjects in six subcategories that include Activity (high energy-level), Happiness (positive disposition), Depression (dysphoria), Anger (negative disposition), Fatigue (low-energy level), and Fear (anxiety level). The test includes a plurality of subscales, each including a plurality of adjectives.

In operation, the test subject is provided with an on-screen query and a variable response and indicia for the test subject to indicate either agreement or disagreement with the response. In preferred embodiments, the query remains constant for each subscale and the response varies among the plurality of adjectives linked to the subscale. Participants are asked to reply to the variable response by selecting the appropriate indicia, for example, by pressing 1, 2, or 3 on the computer keyboard, (that is, “press 1 for yes, 2 for somewhat, and 3 for no”) in response to the query, “How does the word shown below describe how you feel right now?” Once the participant has selected the appropriate indicia, the variable response is changed and the participant replies to the updated variable response. Scores for each of the six scales are produced and stored in a participant database.

The adjectives or responses linked to the Activity subcategory include energetic, lively, alert, spirited, active and steady. The adjectives linked to the Happiness subcategory include good, content, cheerful, satisfied, pleased and happy. The adjectives linked to the Depression subcategory include miserable, discouraged depressed, sad, downcast and gloomy. The adjectives linked to the Anger subcategory are grouchy, enraged, annoyed, angry, furious and irritated. The adjectives linked to the Fatigue subcategory include inactive, weary, drowsy, tired, sluggish, and lazy. The adjectives linked to the Fear (anxiety) subcategory include uneasy, alarmed, insecure, afraid, nervous and anxious. There are also other sets of adjectives which may be associated to these categories

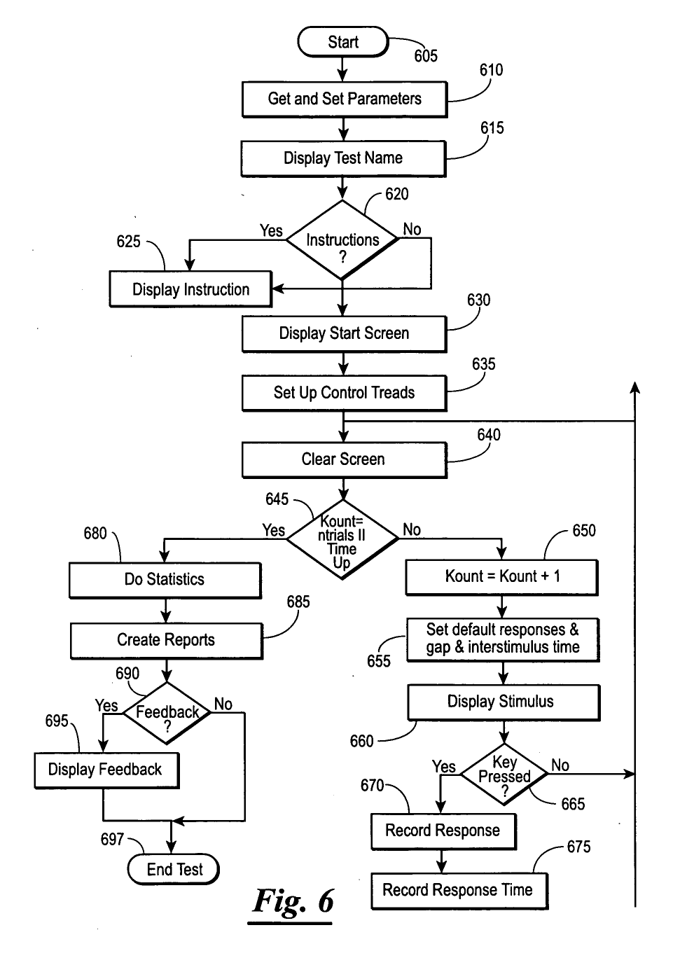

FIG. 6 is a flow diagram illustrating the general steps of an exemplary method of execution for a specific type of test according an embodiment of the present invention. More specifically, FIG. 6 illustrates the steps involved in a type of test that presents a stimulus to the test subject. One of the more popular tests of this type is The Simple Reaction Time Test, which will be specifically described in further detail below.

Referring now to FIG. 6, flow begins with step 605 and proceeds to step 610.

In step 610, a list of switches (parameters) described below is generated. In some embodiments, the USER may select and set one or more of the switches to configure the tests as desired. In other embodiments only the system administrator or his designee has sufficient privileges to set and select switches.

In step 615, the name of the test is preferably displayed on the display screen. Control then proceeds to decision step 620. In decision step 620, the program module prompts the user to determine whether she would like instructions for the test. If the user would like instructions for the test, in step 625, the program module communicates a set of user instructions for taking the test. Returning to decision step 620, if the user elects not to have user instructions displayed, an initial start screen is presented, for example, an introductory screen with graphics.

In step 635, control threads are set. In step 640, the display screen is cleared. Control then passes to decision step 645.

In decision step 645, it is determined whether a count variable (for example, “Kount”) has reached the specified number of trials for ending the program module, or whether the specified time for the session is up. As used herein, a trial is defined as a series of stimuli presentations. That is, a plurality of stimuli may be presented to the test subject in a trial. Preferably, a session is comprised of one or more trials. Now referring back to FIG. 6, in accordance with a specific example, the total number of trials (for example, “ntrials,” in FIG. 6) for the program module may initially have been set to five, and the count variable (for example, “kount,” in FIG. 6) may now specify a value of three.

Continuing with the example offered above, if the current “kount” value (which indicates the current session number) is three and the “ntrials” (total number of trials initially set) variable is five, then there are two more trials left in the test to execute. Thus, control within the program module does not end and proceeds to step 650.

In step 650, the “kount” variable is incremented by one to reflect execution of yet another trial of the test. In other words, the current “kount” value is updated to reflect execution of the present trial.

In step 655, a group of variables is set for the current trial. For example, step 655 illustrates the setting of a default response variable, a gap variable, and an interstimulus variable. The interstimulus variable may indicate the time allowed between stimulus presentations. In step 660, a stimulus is presented on the display screen. Control then proceeds with decision step 665. In decision step 665, it is determined whether an input device has been activated. For example, a user may depress a key on the keyboard or computer mouse to respond to the stimulus as instructed by the Simple Reaction Time test. If it is determined that the test subject has activated an input device in decision step 665, control resumes with step 670, and the test subject's response to the stimulus is recorded. In step 675, the length of time it took the test subject to respond to the test is also recorded.

Returning to decision step 665, if it is determined that the user did not activate the input device, control resumes with step 640, where the display screen is cleared. Returning to decision step 645, if the current trial number (that is, the “kount” variable) has reached the number stored in the “ntrials” number (or the time allotted for testing has expired), no further trials of the program module will be executed. Control then resumes with step 680.

In step 680, the statistics for the test subject's performance are calculated. In step 685, at least one report of the statistics is created. Control then proceeds with decision step 690, in which it is determined whether feedback (that is, performance results from the test) from the user's performance is to be displayed on the display screen. If it is determined that feedback from the user's performance is to be displayed on the screen, the feedback is displayed in step 695. If it is determined that feedback is not to be displayed in decision step 690, control of the testing program module ends in step 697. In some embodiments, it may be desirable to prevent the test subject from viewing the test results and to only allow the USER to view the test results. It should be noted that a test subject may desire to save the report created in step 685 to a disk drive, for example, for later viewing. The following are examples of neuropsychological tests of the type described with respect to FIG. 6.

Simple Reaction Time

This is a test designed to provide a measure of pure reaction time, an important aspect of neurocognitive assessment. In operation, a simple stimulus is presented on screen, and the participant is instructed to input a response each time the stimulus is presented. When the stimulus is presented, it remains on screen for a predetermined period of time hereinafter referred to as the RT period. The RT period may be adjusted as desired by the test administrator. For example, when testing a jet pilot it may be desirable to have a very short RT period that requires a quick response. However, when testing a subject who's reflexes are not as keen, for example, Alzheimer's candidates, it may be desirable to have a longer RT period, thus allowing slower response times. Similarly, the presentation rate of the stimulus may be varied as desired by the administrator.

2-Choice Reaction Time

This test is similar to the Simple Reaction Time Test except that two different stimulus characters are presented, for example, “+” and “*”. The pattern of presentation of the stimulus, the RT period and the rate of presentation may be adjusted by the USER as desired.

Spatial Processing

In this test, a pair of four bar histograms is displayed as pairs, and the subject is requested to determine whether they are identical. One histogram is preferably rotated either approximately 90° or approximately 270° with respect to the other histogram. The subject may respond to indicate that the two histograms are either the same or different using the input device.

Running Memory (Continuous Performance Test)

This test is intended to index the test subject's concentration level and attention span. The test requires the subject to continuously compare characters, for example, numbers or symbols. In operation, characters are presented on screen one at a time, preferably in the center of the screen. In accordance with a preferred aspect of the invention, the characters are presented in a pseudo random order. Prior to being presented with the characters, test subjects are instructed to continuously monitor the characters and input a response using an input device if the character on screen matches the character that immediately preceded it. The test subject is instructed to input a different response, that is, press another key or button, if the character on screen does not match the character that immediately preceded it.

Each character may be displayed on the screen for a period of time that may be selected by the USER prior to administration of the test. In addition, the test administrator may select/adjust the period of time between presentations of successive characters. For example, characters may be presented either after a predetermined time has elapsed or responsive to the test subject's response input, whichever occurs first. In preferred embodiments, characters should be displayed as described in connection with this test for about five minutes to effectively assess the subject's concentration level and attention span.

Symbolic & Procedural Reaction Time (Modified Stress RT Tasks)

In this test, a variety of characters are presented on screen, one at a time and preferably in the center of the screen. In a preferred embodiment, four distinct characters are presented. For example, the characters may include shapes or alphanumeric characters. The test subject is instructed to input a first specified response each time first and second characters are detected and to input a second specified response each time third and fourth characters are detected. The test subject may input its response by depressing specified keys on a keyboard, by selecting a specified input using a mouse, or by using any other known input procedure.

In accordance with an aspect of the invention, in one embodiment, the character quality is normal and the characters are presented at regular intervals. In accordance with another embodiment, the character quality is degraded and the characters are presented at regular intervals. In accordance with still another embodiment, the character quality is normal but the characters are presented at irregular intervals. Advantageously, the test administrator may control the duration and period of the intervals without reconfiguring program code (that is, this is a user controllable parameter).

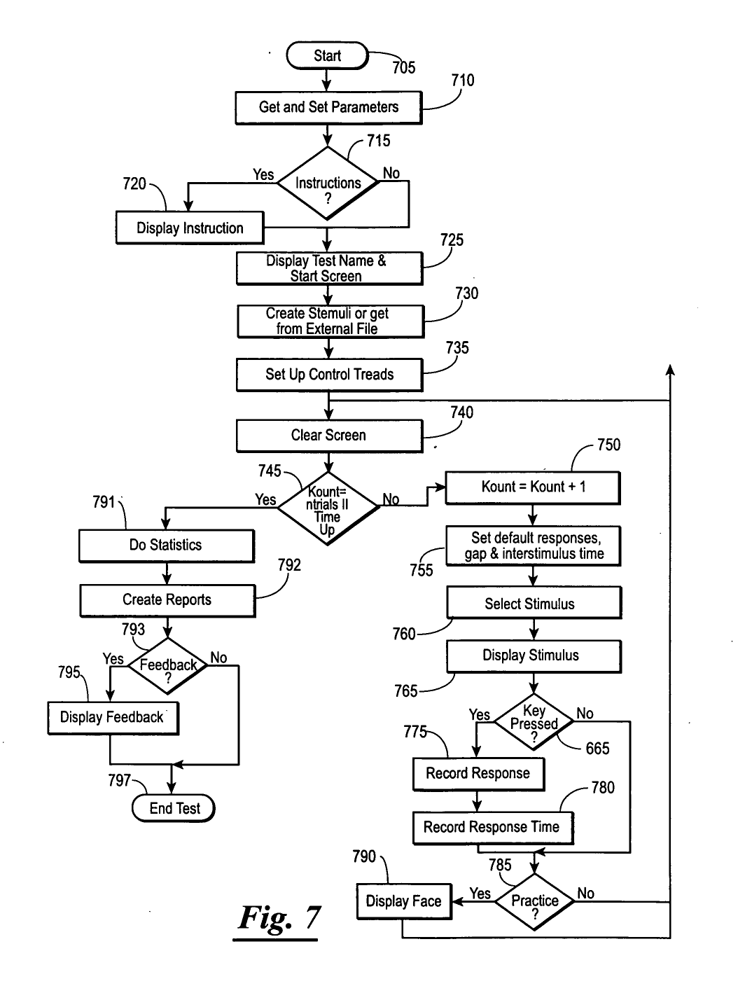

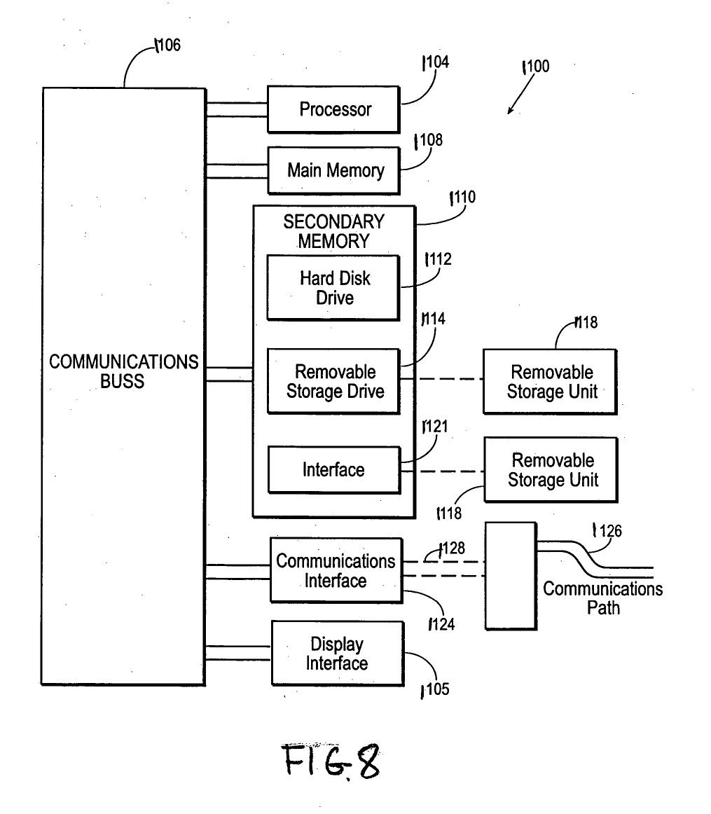

FIG. 7 is a flow diagram illustrating the general steps of an exemplary method of execution for a type of test that presents a stimulus and provides an option for a practice session. The Mathematical Processing Test is a common test of this type. Flow begins with step 705 and proceeds to step 310. In step 710, a list of switches (parameters) described below is generated. The USER may select and set one or more of the switches to configure the tests as desired.

In decision step 715, the program module prompts the user to determine whether she would like user instructions for the test. If the user would like user instructions for the test, in step 720, the program module displays a set of user instructions instructing the user how the test works. Returning to decision step 715, if the user elected not to have user instructions displayed, in step 725, the name of the test is displayed, and an initial start screen is presented (for example, an introductory screen with graphics). In step 730, stimuli are presented. For example, the Mathematical Processing Test displays a mathematical problem to the test subject on a display screen. In particular situations, the stimuli or mathematical problems may be stored in an auxiliary file, for example.

In step 735, control threads are set. In step 740, the display screen is cleared. Control then passes to decision step 745.

In decision step 745, it is determined whether a count variable has reached the specified number of trials for ending the program module, or whether the specified time for the session is up. For example, the total number of trials (for example, “ntrials,” in FIG. 7) for the program module may initially have been set to five by the user, and the count variable (for example, “kount,” in FIG. 7) may now specify a value of three.

Continuing with the example offered above, if the current “kount” value is three (that is, the current trial is trial number three) and the “ntrials” (total number of trials initially set) variable is five, then there are two more trials left in the test to execute. Thus, control within the Mathematical Processing Test program module does not end and proceeds to step 750, providing that the time allotted for the session has not expired.

In step 750, the “kount” variable is incremented by one to reflect execution of yet another trial. In other words, the current “kount” value is updated to reflect execution of the present trial. In step 755, a group of variables is set for the current trial. For example, step 755 illustrates the setting of a default response variable, a gap variable, and an interstimulus variable. For example, the interstimulus variable may indicate the time allowed between stimulus presentations.

In step 760, a stimulus is selected by the user. In step 765, the stimulus is displayed on the display screen. Control then proceeds with decision step 770. In decision step 770, it is determined whether the test subject has generated input. For example, a user may depress a key on the keyboard or computer mouse to respond to the stimulus as instructed by the test. If it is determined that the test subject has generated input in decision step 770, control resumes with step 775, and the test subject's response to the stimulus is recorded. In step 780, the length of time it took the test subject to respond to the stimulus is recorded. Alternatively, in decision step 770, if it is determined that no input was generated, control proceeds to step 785.

Some tests are rather complex (for example, the Mathematical Processing Test) and thus may present the test subject with practice sessions in which they can learn how to interact with the tests. In such tests, the test subject is prompted to enter whether he desires a practice session after user instructions are displayed.

Thus, in decision step 785, it is determined whether the current session is actually a practice session. If it is determined that the current session is a practice session, in step 790, an encouraging graphical display (that is, some type of positive reinforcement) is presented on the display screen, for example, a “smiley” face. Returning to decision step 785, if it is determined that the current session is not a practice test (that is, if it is determined that the current session is an actual testing session), then control proceeds to step 740, where the screen is again cleared.

Returning to decision step 745, if it is determined that the value for the current trial is equal to the value of the total number of trials set, or if it is determined that the time allotted for the session has expired, then no more trials are to be executed.

In step 791, the statistics for the test subject's performance are calculated. In an optional step 792, at least one report of the statistics is created. Control then proceeds with decision step 793, in which it is determined whether feedback from the test subject's performance is to be displayed on the display screen. If it is determined that feedback from the test subject's performance is to be displayed on the screen, the feedback is displayed in step 795. If it is determined that feedback is not to be displayed in decision step 793, control of the test module ends in step 797. The following are neuropsychological tests of the type described with reference to FIG. 7.

Mathematical Processing

This test is used to assess the test subject's simple arithmetical and concentration abilities. In this test, arithmetic problems are presented on screen, preferably in the middle of the screen. The test requires the subject to deduce an answer and then decide if the answer is greater-than or less-than a specified number, for example, the number five. Each problem includes two mathematical operations (addition and/or subtraction) on sets of three single-digit numbers (for example, 5+3−4=?). The subject is instructed to read and calculate from left to right and indicate whether the answer is greater-than or less-than a given number, for example, five, by pressing one of two specified response buttons/keys. The operators and operandi are selected at random with the following restrictions: only the digits 1 through 9 are used; the correct answer may be any number from 1 to 9 except 5; greater-than and less-than stimuli are equally probable; cumulative intermediate totals have a positive value; working left to right, the same digit cannot appear twice in the same problem unless it is preceded by the same operator on each occasion (for example, +3 and +3 are acceptable, while +3 and −3 are not); and the sum of the absolute value of the digits in a problem must be greater than 5.

Digit Set Comparison

This test is used primarily to index immediate memory and attention. In this test, a string of digits ranging in length from 2 to 10 numbers is presented in the center of the screen. After a specified period, the first string of digits disappears and a second string is presented. The duration of the specified period is adjustable and may be controlled by the USER without alteration of the program code (that is, this is a user controller parameter). The test subject is instructed to compare the two strings of digits and decide if they are the same digits and in the same order. The test subject is further instructed to respond by providing an input.

Logical Reasoning

This test is useful for indexing ability for abstract reasoning and verbal syntax. It is a linguistic task requiring knowledge of English grammar and syntax. It also requires the ability to determine whether various simple sentences correctly describe the relational order of two symbols. In this task, stimulus pairs may be presented one at a time and are preferably screen-centered rather than left justified to reduce differences in visual search times.

On each trial the symbol pair “# &” or “& #” is displayed along with a statement that correctly or incorrectly describes the order of the letters as depicted in the example below:

&#

# is first

The subject is instructed to decide as quickly as possible whether the statement is true or false and then to provide an input indicating the response.

Code Substitution and Memory Test

In this test, a string of preferably up to 9 symbols and 9 digits may be displayed across the upper portion of the screen and preferably arranged so that the digit string is immediately below the symbol string. There is one digit corresponding to each symbol. During the test, a test pair (a symbol and corresponding digit) may be presented at the bottom of the screen, below the digit/symbol string. The goal of the test is to determine whether the test pair matches any associated pair in the string. The test taker may respond using an input device to indicate that the test symbol and digit are a correct or incorrect pairing.

The initial presentation is a visual scanning and learning procedure. The ratio of correct to incorrect displays is preferably 3:1, and each pair is preferably presented a minimum of 8 times yielding at least 6 correct presentations and at least two incorrect presentations per digit symbol set.

An associative recognition memory trial is then presented immediately and at a selected time interval following the learning trial, the time interval being controllable by the USER without modification of program code. During this portion of the test, the procedure is essentially the same as the learning procedure. However, the comparison coding strings are not displayed. Only the test stimuli are presented and the subject has to indicate whether the displayed pair is correct or incorrect based on the subject's recollection of the paired associates presented during the learning trial. The ratio of correct to incorrect presentations during the associative recognition trial is preferably approximately 1:1. So there is about a fifty percent chance of being presented with a correctly matched symbol and digit pair.

Matching to Sample

In this test, the subject is asked to respond to stimuli that correspond in some fashion to a sample stimulus. In a preferred embodiment, a 4×4 matrix (checkerboard) is initially presented in the center of the screen as a sample stimulus to the subject. For each trial presentation of a matrix, the number of cells that are shaded may be varied at random from only one cell to twelve cells. When the subject responds via the input device or after a predetermined period of time, for example, thirty seconds, the sample matrix is removed from the screen. Following a second predetermined time interval, for example, twenty seconds, a set of two comparison matrices are presented side by side on the screen. One of the comparison matrices matches the sample matrix and the other comparison matrix preferably differs in shading from the sample by one cell. The subject's task is to indicate using the input device, which matrix matches the sample matrix.

Memory Search (Sternberg RT & Symbolic)

This test is useful for indexing the subject's working memory. In accordance with the invention, a set of characters is displayed horizontally, preferably in the center of the monitor. The set of characters is referred to herein as the “memory set”. The test subject should view the memory set until it is memorized. The memory set is preferably comprised of 2, 4, or 6 letters and/or symbols. However, the number of characters that comprise the memory set may be varied by the administrator to accommodate the testing environment.

After the memory set has been learned, the subject generates an input, for example, presses a response key, to begin the test. During this part of the test, single “probe” letters or symbols are presented preferably in the center of the screen, and preferably one at a time. The subject indicates whether or not the probe matches any of the memory set items. Responses may be entered by pressing a specified key or mouse button. Each probe remains on the screen until the subject responds or until a pre-selected time limit has elapsed. The screen is cleared momentarily between successive probe presentations.

In keeping with a particularly preferred aspect of the invention, each successive administration of the test uses a unique memory set. Memory set letters are preferably selected randomly from the following list: A, B, C, E, F, G, H, I, J, K, L, M, Q, R, S, T, U, X, Y. Or the memory set could comprise digits or other symbols. The memory set characters are preferably centered horizontally in the middle of the screen with one character space between each letter. Positive probes, that is, probes that match one of the memory set characters, are equally likely to match any of the memory set letters. Further, positive and negative probes (probes that do not match any of the memory set characters) are presented in an equal-probability randomized or pseudo-randomized order. In constructing the memory set, it is desirable to exclude characters that are similar in appearance. For example, in the preferred embodiment, the letters U and V were expressly excluded from the memory set so as not to be mistaken, one for the other.

In addition to the various automated individual neuropsychological testing program modules, according to embodiments of the present invention, each neuropsychological program module may be customized by controlling a variety of parameters, switches, or variables relating to a variety of functions for each test. The switches include but are not limited to the following: (1) RESPONSE_KEYS, (2) STIM_DURATION, (3) HAND, (4) RESPONSE_DEVICE, (5) EYE, (6) PRACTICE_MODE, (7) STIMULUS_SET, (8) RANDOM_SEED, (9) TRIAL_TIMELIMIT, (10) SOUND_TOGGLE, (11) HEMISPHERE_ORDER, (12) SUB_BLOCKS, (13) ISI_LEVEL, (14) SET_SIZE, (15) NUMBER_OF_TRIALS, (16) TARGET_SPEED, (17) VIEW_DELAY.

RESPONSE_KEYS

The RESPONSE_KEYS switch specifies a keyboard string that denotes acceptable keys on the keyboard for user input. For example, if the RESPONSE_KEYS switch is A,B,C, and D, these are the keys the system will recognize as providing user input. Thus, a user must use these keys to interact with the program modules.

STIM_DURATION

The STIM_DURATION switch specifies the presentation time for a particular stimulus in milliseconds, for example. It determines how long the stimulus will be displayed on the display device. For example, some of the neuropsychological tests feature a presentation of stimuli to a test subject. A flashing snowflake, for example, may be presented on a display device as part of the particular neuropsychological test (for example, the Simple Reaction Test). During program execution, the USER can select an option to specify the period and/or frequency upon which the star will flash (for example, five milliseconds) as well as the flash duration.

HAND

The HAND switch indicates which one of the test subject's hands is the response hand. For example, a value of ‘1’ may indicate the subject is left-handed, and a value of ‘2’ may indicate the subject is right-handed.

RESPONSE_DEVICE

The RESPONSE_DEVICE switch indicates the device the test subject is using to interact with the program modules. For example, a value of ‘0’ indicates that the subject is using a keyboard, and a value of ‘1’ indicates that the subject is using a mouse.

EYE

The EYE switch indicates which eye of the test subject is receiving the stimulus. For example, ‘0’ may indicate the right eye, and ‘1’ may indicate the left eye.

PRACTICE_MODE

The PRACTICE_MODE switch indicates the various levels of feedback for the practice modes. For example, a value of ‘0’ indicates that the practice mode is off, a value of ‘1’ indicates positive, a value of ‘2’ indicates negative, and a value of ‘3’ indicates both.

STIMULUS_SET

The STIMULUS_SET switch defines a stimulus set to be used for those tasks of a program module which are driven by external files (for example, memory search or mathematical processing). It requires that the filename which contains the stimulus set (more than one stimulus presentation) be specified.

RANDOM_SEED

The RANDOM_SEED switch seeds the random number generator. For example, a stimulus for a particular test may be presented in a random, preferably pseudo-random fashion. To generate the “randomness,” a seed can be specified to increase or decrease “randomness.”

TRIAL_TIMELIMIT

The TRIAL_TIMELIMIT indicates the length of time for a given trial. For example, a value less than zero indicates an “infinite” time (no timeout).

SOUND_TOGGLE

The SOUND_TOGGLE switch specifies whether a particular program module should use audio.

HEMISPHERE_ORDER

The HEMISPHERE_ORDER switch defines the brain hemisphere ordering for tasks that require it. For example, the switch may have a value of ‘R’ (indicating right brain), ‘L’ (indicating left brain), RL (indicating right brain/left brain), or LR (indicating left brain/right brain).

SUB_BLOCKS

The SUB_BLOCKS switch is used in conjunction with a task that includes definable sections. The switch allows definition of the order in which the sub-blocks are run. For example, 1341 may be used to define the block order for a particular task as 1, 3, 4, 1.

ISI_LEVEL

The ISI_LEVEL switch selects the predefined interstimulus level. For example, the value for the switch may be an integer representing a range of values (seconds, for example) that are randomly chosen.

SET_SIZE

The SET_SIZE switch defines the size of a set used by a particular program module. For example, the memory set size used by the Memory Search Test may be specified as four items per set.

NUMBER_OF_TRIALS

The NUMBER_OF_TRIALS switch specifies the number of stimuli presented by a particular task.

TARGET_SPEED

The TARGET_SPEED switch controls the speed of a moving cursor, for example. For example, the value of the switch may be specified in millimeters/second.

VIEW_DELAY

The VIEW_DELAY switch specifies the minimum view delay in milliseconds, for example, for a stimulus memory set.

In addition to the parameters described above, the present invention offers the USER an option to alter a switch or parameter value for the contrast of a given stimulus, for example. Such features allow the USER to tailor the program to meet the needs of specific individuals and to test for different conditions. For example, many elderly test subjects may have slower reflexes than their younger counterparts. Thus, their reaction time to the testing stimulus may be less. Accordingly, when taking the Simple Reaction Time Test, for example, elderly test subjects may require that the flashing snowflake not flash as it would for a younger subject. As a result, they may require that the flashing snowflake not flash as frequently as it would for a younger subject. However, the USER may be interested in monitoring degradation of reaction time as a function of age and thus may not choose to alter the stimulus frequency.

In at least one embodiment of the present invention, the test module may include a test battery, i.e., a specific combination of individual neuropsychological tests used to analyze a given condition.

The invention can take the form of an entirely hardware embodiment, an entirely software embodiment or an embodiment containing both hardware and software elements. In a preferred embodiment, the invention is implemented in software, which includes but is not limited to firmware, resident software, microcode, etc, that cause a client-computing device to perform the functions specified herein.

Furthermore, the invention can take the form of a computer program product accessible from a computer-usable or computer-readable medium providing program code that causes a computer or any instruction execution system to perform the tasks and functions described herein. For the purposes of this description, a computer-usable or computer readable medium can be any apparatus that can contain, store, communicate, propagate, or transport the program for use by or in connection with the instruction execution system, apparatus, or device.

The medium can be an electronic, magnetic, optical, electromagnetic, infrared, or semiconductor system (or apparatus or device) or a propagation medium. Examples of a computer-readable medium include a semiconductor or solid-state memory, magnetic tape, a carrier wave, a removable computer diskette, a random access memory (RAM), a read-only memory (ROM), a rigid magnetic disk and an optical disk. Current examples of optical disks include compact disk-read only memory (CD-ROM), compact disk-read/write (CD-R/W) and DVD.

A client-computing device suitable for storing and/or executing program code will include at least one processor coupled directly or indirectly to memory elements through a system bus. The memory elements can include local memory employed during actual execution of the program code, bulk storage, and cache memories which provide temporary storage of at least some program code in order to reduce the number of times code must be retrieved from bulk storage during execution.

Input/output or I/O devices (including but not limited to keyboards, displays, pointing devices, etc.) can be coupled to the client-computing device either directly or through intervening I/O controllers.

Network adapters may also be coupled to the client-computing device to enable the data processing system to become coupled to other data processing systems or remote printers or storage devices through intervening private or public networks. Modems, cable modem and Ethernet cards are just a few of the currently available types of network adapters.

As used herein the term client-computing device refers to a microprocessor-based device suitable for executing computer program modules and computer program control modules of the present invention. The microprocessor may be disposed on a single platform such as a desktop computer, laptop computer, palmtop computer, or personal digital assistant (PDA), a mobile telephone or the like. Exemplary computers may include, but are not limited to, Apple®, Sun Microsystems®, IBM®, or IBM®-compatible personal computers. Accordingly, the present invention may be carried out and disposed on a single platform. Preferably, the present invention is implemented using an IBM®-compatible computer system having minimum specifications of a Pentium® 90 MHz microprocessor, at least 32 MB RAM, and at least 4 MB free disk space.

Referring to FIG. 1, an exemplary client-computing device is shown. The client-computing device 100 includes one or more processors, such as processor 104. The processor 104 is connected to a communications bus 106. It should be noted, however, that the processor 104 could also be connected to a crossover bar or another network. It should also be noted that various software embodiments are described in terms of the exemplary computer system depicted in FIG. 1. The skilled artisan will readily recognize that the invention may be implemented using other computer systems and/or computer architectures.

Client computing device 100 may include a communications interface 124 that forwards graphics, text, and other data from the communications bus 106 for display on a display device (not shown).

Client computing device 100 also includes a main memory 108, preferably random access memory (RAM), and may also include a secondary memory 110. The secondary memory 110 may include, for example, a hard disk drive 112 and/or a removable storage drive 114, representing a floppy disk drive, a magnetic tape drive, or an optical disk drive, etcetera. The removable storage drive 114 reads from and/or writes to a removable storage unit 118 in a manner well known to those skilled in the art. Removable storage unit 118 represents a floppy drive, magnetic tape, memory stick, or optical disk. As will be appreciated by those skilled in the art, the removable storage unit 118 includes a computer usable storage medium having stored therein computer software and/or data.

In alternative embodiments, secondary memory 110 may include other similar means for allowing the neuropsychological computer program modules of the present invention to be loaded into client computing device 100. Such means may include, for example, a removable storage unit 118 and an interface 121. Examples of such may include a program cartridge and cartridge interface (such as that found in video game devices), a removable memory chip (such as an EPROM or PROM) and associated socket, and other removable storage units 122 and interface 121 which allows software and data to be transferred from the removable storage unit 122 to the client computing device 100.

Client computing device 100 may also include a communications interface 124. The communications interface 124 allows software and data to be transferred between the client-computing device 100 and external devices. Examples of the communications interface 124 include a modem, a network interface, an Ethernet card, a communications port, and a PCMCIA slot and card. Software and data transferred via the communications interface 124 are in the form of signals 128, which may be electronic, electromagnetic, optical, or other signals capable of being received by the communications interface 124. The signals 128 are provided to the communications interface 124 via a communications path (for example, a channel) 126. The path 126 carries signals 128 and may be implemented using wire, cable, fiber optics, a phone line, a cellular phone link, and RF link and other communications channels.

Although shown and described is what is believed to be the most practical and preferred embodiments, it is apparent that departures from specific designs and methods described and shown will suggest themselves to those skilled in the art and may be used without departing from the spirit and scope of the invention. The present invention is not restricted to the particular constructions described and illustrated, but should be constructed to cohere with all modifications that may fall within the scope of the appended claims.

We claim:

1. A method for administering automated neuropsychological tests on a client computing device where test modules are stored at a remote location comprising:
prompting a user for login information;
validating login information;
accessing a user information file resident at a first location device responsive to login information;
accessing a study information file resident at a second location device responsive to login information, the study information file including one or more test modules;
retrieving test modules from a third remote location for each test in the one or more test batteries;
executing the test modules thereby generating test data files;
transmitting the test data files to a fourth remote location; and
deleting the test data files and test modules from the client-computing device.

2. The method of claim 1 wherein the user file includes a plurality of test modules and wherein the retrieving, executing, transmitting and deleting steps are completed for a first test module prior to retrieving a second test module.

3. The method of claim 1 wherein retrieving the test module includes downloading the test module onto the client computing device.

4. The method of claim 1 wherein the user information file includes a test run count.

5. The method of claim 4 further comprising updating the test run count after a test is executed.

6. The method of claim 5 further comprising sending the updated test run count to the first remote device.

7. The method of claim 1 wherein the first, second, third and fourth remote location are disposed on a single remote device.

8. The method of claim 7 wherein the remote device is a server.

9. The method of claim 1 wherein the first and second remote locations are disposed on a first remote device and the third and fourth remote locations are disposed on a second remote device.

10. A computer program product comprising a computer useable medium including a computer readable program, wherein the computer readable program when executed on a computer causes the computer to:
prompt a user for login information;
validate login information;
access a user information file resident at a first location device responsive to login information;
access a study information file resident at a second location device responsive to login information, the study information file including one or more test modules;
retrieve test modules from a third remote location for each test in the one or more test batteries;
execute the test modules thereby generating test data files;
transmit the test data files to a fourth remote location; and
delete the test data files and test modules from the client computing device.

11. A computer data signal embodied in a carrier wave including the computer readable program of claim 10.
